(19) United States
(12) Patent Application Publication
(10) Pub. No.: US 2023/0376756 A1
(43) Pub. Date: Nov. 23, 2023

(54) 3D POINT CLOUD-BASED DEEP LEARNING NEURAL NETWORK ACCELERATION APPARATUS AND METHOD

(71) Applicant: Korea Advanced Institute of Science and Technology, Daejeon (KR)

(72) Inventors: Hoi Jun YOO, Daejeon (KR); Dong Seok IM, Daejeon (KR)

(73) Assignee: Korea Advanced Institute of Science and Technology, Daejeon (KR)

(21) Appl. No.: 18/199,995

(22) Filed: May 22, 2023

(30) Foreign Application Priority Data
May 23, 2022 (KR) 10-2022-0063062

(51) Int. Cl. G06N 3/08

(52) U.S. Cl. CPC G06N 3/08

(57) ABSTRACT

Disclosed is a 3D point cloud-based deep learning neural network acceleration apparatus including a depth image input unit configured to receive a depth image, a depth data storage unit configured to store depth data derived from the depth image, a sampling unit configured to sample the depth image in units of a sampling window having a predetermined first size, a grouping unit configured to generate a grouping window having a predetermined second size and to group inner 3D point data by grouping window, and a convolution computation unit configured to separate point feature data and group feature data, among channel-direction data of 3D point data constituting the depth image, to perform convolution computation with respect to the point feature data and the group feature data, to sum the results of convolution computation by group grouped by the grouping unit, and to derive the final result.

### BACKGROUND OF THE INVENTION

### Field of the Invention

The present invention relates to a 3D point cloud-based deep learning neural network acceleration apparatus and method, and more particularly to a neural network acceleration apparatus and method capable of effectively accelerating a 3D point cloud-based deep learning neural network.

### Description of the Related Art

A 3D point cloud-based deep learning neural network is a neural network that performs 3D recognition based on input of 3D data constituted by a combination of an RGB image and distance information. When the 3D point cloud-based deep learning neural network is used, it is possible to more accurately recognize an object in the real world than when using 2D image data. The 3D point cloud-based deep learning neural network may be applied to AR/VR applications, autonomous driving applications, robotic automation, etc.

In order to perform 3D recognition from 3D data, the 3D point cloud-based deep learning neural network samples 3D point data, groups adjacent 3D point data based on the sampled 3D point data, and performs convolution computation with respect to the result of grouping (Reference Document 1 and Reference Document 2).

In order to uniformly sample and group 3D point data, it is necessary to define the relationship between the adjacent 3D point data. Conventionally, distance information between all 3D data must be acquired, whereby a large amount of memory access and a large amount of computation are required.

Conventionally, for example, in order to uniformly sample 3D point data, all 3D point data distant from each other by a specific distance or more must be sampled (Reference Document 3).

In addition, conventionally, in order to group adjacent 3D point data based on the sampled 3D point data, a ball query method of grouping all 3D point data located within a specific distance or a K-nearest neighbor (KNN) algorithm method of grouping the nearest 3D point data was used.

Conventionally, as described above, distance information between 3D point data in the entirety of a 3D point cloud is calculated, and 3D point data located within a specific distance or the nearest 3D point data are selected, whereby a huge amount of memory access and a huge amount of computation are required.

Also, in convolution computation with respect to 3D data, there are various scarcities for each of input and output data of a convolution layer, and therefore it is difficult to efficiently perform acceleration using a conventional deep learning accelerator.

For example, in convolution computation having the result of grouping of 3D point data as input, data sparsity is low (e.g. less than 10%), whereby acceleration is difficult. Furthermore, during grouping of 3D point data, duplicate computation is performed due to arbitrary 3D point data belonging to several groups, whereby unnecessary computation occurs.

In addition, for the other convolution layers, input data sparsity is present due to the ReLU activation function, whereby 0 value computation occurs, which is not skipped.

Meanwhile, for the last convolution layer, 64-to-1 max-pooling computation is performed; however, max-pooling computation is performed with respect to all output data, whereby unnecessary computation with respect to output data occurs (Reference Document 4).

Since the 3D point cloud-based deep learning neural network exhibits various computation features depending on input/output data of a convolution layer, as described above, it is difficult to perform acceleration using the conventional accelerator. In addition, computation skipping due to input/output scarcity cannot be performed, whereby unnecessary computation occurs.

### PRIOR ART DOCUMENTS

### Non-Patent Documents

(Non-Patent Document 0001) Reference Document 1: C. Qi et al., DEEP HIERARCHICAL FEATURE LEARNING ON POINT SETS IN A METRIC SPACE, NeurIPS, 2017
(Non-Patent Document 0002) Reference Document 2: C. Qi et al., HOUGH VOTING FOR 3D OBJECT DETECTION IN POINT CLOUDS, ICCV, pp. 9277-9286, 2019
(Non-Patent Document 0003) Reference Document 3: R. Bridson, POISSON DISK SAMPLING IN ARBITRARY DIMENSIONS, SIGGRAPH sketches, 10(1), 1, 2007
(Non-Patent Document 0004) Reference Document 4: D. Im, 4.45 MS LOW-LATENCY 3D POINT CLOUD-BASED NEURAL NETWORK PROCESSOR FOR HAND POSE ESTIMATION IN IMMERSIVE WEARABLE DEVICES, IEEE Symposium on VLSI Circuits, pp. 1-2, 2020

### SUMMARY OF THE INVENTION

The present invention has been made in view of the above problems, and it is an object of the present invention to provide a 3D point cloud-based deep learning neural network acceleration apparatus and method capable of limiting a search area of a window-based 3D point search algorithm to units of a window having a size of N×N (N=4, 8, 12, 16, whereby it is possible to greatly reduce the amount of external memory access and the amount of computation, and therefore it is possible to increase speed.

It is another object of the present invention to provide a 3D point cloud-based deep learning neural network acceleration apparatus and method capable of performing control such that, during window search-based 3D point data sampling and grouping, sampling and grouping modules share a hardware unit configured to support window search computation and a memory configured to store the results of sampling and grouping, whereby it is possible to reduce consumption of hardware resources.

It is another object of the present invention to provide a 3D point cloud-based deep learning neural network acceleration apparatus and method capable of, when convolution computation is performed with respect to the result of grouping, slicing computation target data to upper bits and lower bits and performing unit computation using the sliced data, whereby it is possible to skip sparse input computation, and therefore it is possible to accelerate convolution computation.

It is another object of the present invention to provide a 3D point cloud-based deep learning neural network acceleration apparatus and method capable of performing computation with respect to upper bit data first to predict the position of the max-pooling maximum value and skipping computation with respect to lower bit data at different positions from the position of the max-pooling maximum value, whereby it is possible to skip output computation, and therefore it is possible to accelerate convolution computation.

It is another object of the present invention to provide a 3D point cloud-based deep learning neural network acceleration apparatus and method capable of separating point feature data, which are not affected by a group value, thereby having the same value, and group feature data, which are affected by the group value, thereby having different values depending on group, among channel-direction data of 3D point data belonging to a plurality of groups, during grouping, and performing convolution computation with respect to the point feature data and the group feature data, whereby it is possible to omit duplicate computation with respect to the point feature data, therefore it is possible to accelerate convolution computation.

It is a further object of the present invention to provide a 3D point cloud-based deep learning neural network acceleration apparatus and method capable of performing convolution computation with respect to the point feature data and convolution computation with respect to the group feature data by parallel processing, whereby it is possible to further accelerate convolution computation.

In accordance with an aspect of the present invention, the above and other objects can be accomplished by the provision of a 3D point cloud-based deep learning neural network acceleration apparatus including a depth image input unit configured to receive a depth image, which is a training target, a depth data storage unit configured to store depth data derived from the depth image, a sampling unit configured to sample the depth image in units of a sampling window having a predetermined first size, a grouping unit configured to generate a grouping window having a predetermined second size based on the result of sampling and to group inner 3D point data by grouping window, and a convolution computation unit configured to separate point feature data, which are not affected by a group value, and group feature data, which are affected by the group value, among channel-direction data of 3D point data constituting the depth image, to perform convolution computation with respect to the point feature data and the group feature data, to sum the result of convolution computation with respect to the point feature data and the result of convolution computation with respect to the group feature data by group grouped by the grouping unit, and to derive the final result.

In accordance with another aspect of the present invention, there is provided a 3D point cloud-based deep learning neural network acceleration method including a sampling step of sampling a depth image, which is a training target, in units of a sampling window having a predetermined first size, a grouping step of generating a grouping window having a predetermined second size based on the result of sampling and grouping inner 3D point data by grouping window, a first convolution computation step of separating only point feature data, which are not affected by a group value, from channel-direction data of all 3D point data included in the depth image, performing convolution computation with respect to the point feature data, and storing the result of convolution computation, a second convolution computation step of separating only group feature data, which are affected by the group value, from channel-direction data of 3D point data constituting each group by grouped group, performing convolution computation with respect to the group feature data, and storing the result of convolution computation, and a final computation step of summing the result of computation in the first convolution computation step and the result of computation in the second convolution computation step with respect to each of the 3D point data constituting each group by group.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic block diagram showing a 3D point cloud-based deep learning neural network acceleration apparatus according to an embodiment of the present invention;

FIG. 2 is a view schematically illustrating a window search-based sampling and grouping algorithm reflected in an embodiment of the present invention;

FIG. 3 is a view showing an example of a processing unit configured to perform sampling and grouping in accordance with an embodiment of the present invention;

FIG. 4 is a view schematically illustrating an example of a processing process of dividing point feature data and group feature data from each other, performing convolution computation, and performing summation in accordance with an embodiment of the present invention;

FIG. 5 is a view schematically illustrating an example of the structure of a memory configured to store data generated during convolution computation illustrated in FIG. 4;

FIG. 6 is a view schematically illustrating a convolution computation process having sparse input and output computation skipping applied thereto by slice-computing a computation target in accordance with an embodiment of the present invention;

FIG. 7 is a view schematically illustrating an example of the structure of a bit-slice computer configured to perform convolution computation illustrated in FIG. 6; and

FIGS. 8 to 13 are flowcharts showing a 3D point cloud-based deep learning neural network acceleration method according to an embodiment of the present invention.

### DETAILED DESCRIPTION OF THE INVENTION

Hereinafter, embodiments of the present invention will be described with reference to the accompanying drawings, and the present invention will be described in detail to the extent to which a person having ordinary skill in the art to which the present invention pertains can easily implement the present invention. However, the present invention may be implemented in various different forms and is not limited to the embodiments described herein. Meanwhile, parts having no relation to the description of the present invention are omitted from the drawings in order to clearly describe the present invention, and similar parts are denoted by similar reference numerals throughout the specification. In addition, parts that can be easily understood by those skilled in the art even though a detailed description thereof is omitted will not be described.

When a certain part includes a certain component in the specification and the claims, this means that another component is not excluded but is further included, unless mentioned otherwise.

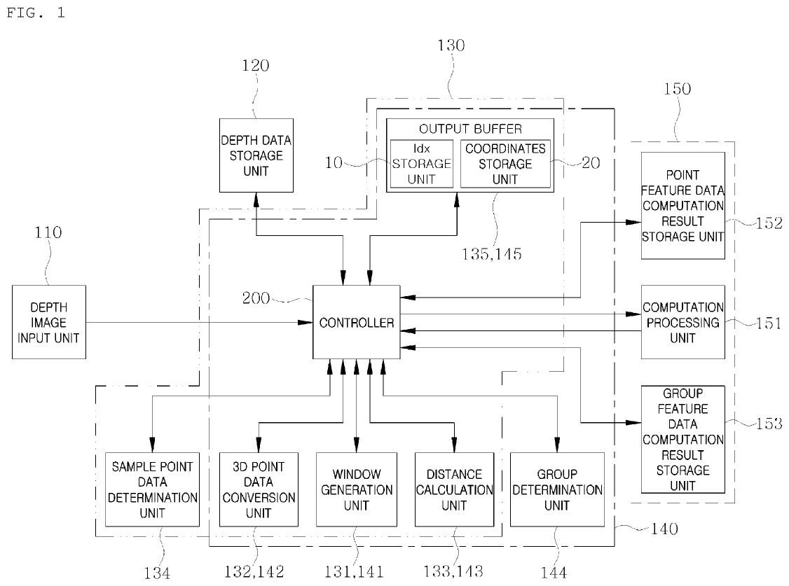

FIG. 1 is a schematic block diagram showing a 3D point cloud-based deep learning neural network acceleration apparatus according to an embodiment of the present invention. Referring to FIG. 1, the 3D point cloud-based deep learning neural network acceleration apparatus according to the embodiment of the present invention includes a depth image input unit 110, a depth data storage unit 120, a sampling unit 130, a grouping unit 140, a convolution computation unit 150, and a controller 200.

The controller 200 controls the operation of the 3D point cloud-based deep learning neural network acceleration apparatus according to the embodiment of the present invention based on a predetermined control algorithm. To this end, the controller 200 may store a predetermined sampling algorithm for controlling the sampling unit 130, a predetermined grouping algorithm for controlling the grouping unit 130, and a predetermined computation algorithm for controlling the convolution computation unit 150 in advance, and may control the operation of the sampling unit 130 based on the sampling algorithm, the operation of the grouping unit 140 based on the grouping algorithm, or the operation of the convolution computation unit 150 based on the computation algorithm. Consequently, when the controller 200 controls the operation of the sampling unit 130, as described above, the controller 200 may be called a sampling controller. In addition, when the controller 200 controls the operation of the grouping unit 140, the controller 200 may be called a grouping controller, and when the controller 200 controls the operation of the convolution computation unit 150, the controller 200 may be called a computation controller.

The depth image input unit 110 receives a depth image, which is a training target.

The depth data storage unit 120 stores depth data derived from the depth image. To this end, the controller 200 may derive depth data from the depth image, and may store the depth data in the depth data storage unit 120.

The sampling unit 130 samples the depth image, and the grouping unit 140 groups 3D point data included in the depth image based on the result of sampling. At this time, the sampling unit 130 and the grouping unit 140 search the depth image using a 3D point data search algorithm, and a search area is limited to units of a window (i.e. search window) having a size of N×N (N being a multiple of 4).

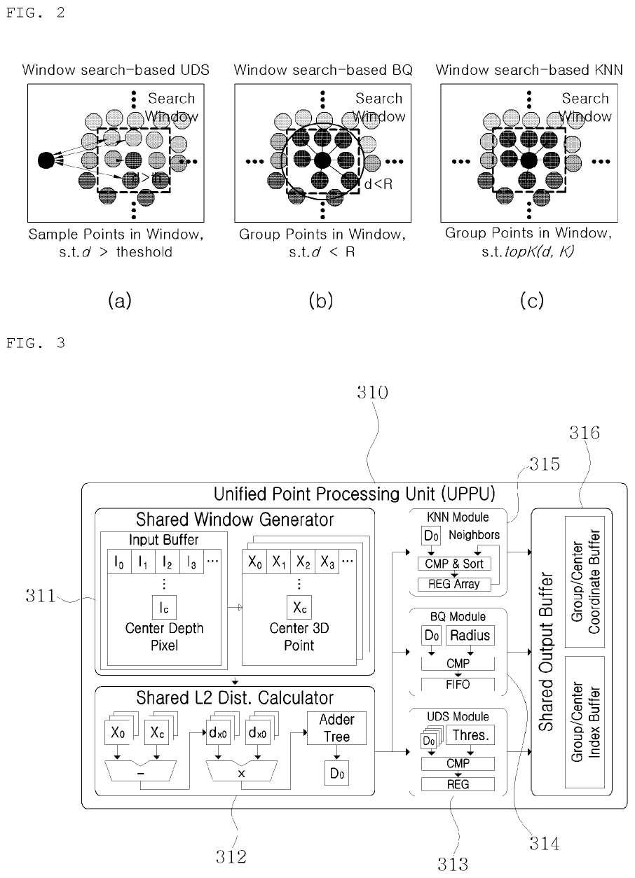

FIG. 2 is a view schematically illustrating a window search-based sampling and grouping algorithm reflected in an embodiment of the present invention, wherein FIG. 2(a) illustrates a search window-based 3D point sampling algorithm, FIG. 2(b) illustrates a search window-based ball query algorithm, and FIG. 2(c) illustrates a search window-based K-nearest neighbor algorithm.

As described above, the present 3D point cloud-based deep learning neural network acceleration apparatus according to the embodiment of the present invention has an advantage in that the search area is limited to units of a search window having a predetermined size, whereby it is possible to greatly reduce the amount of external memory access and the amount of computation. For example, for 3D point sampling, when the size of the search window is set to 4×4, it is possible to reduce the amount of external memory access and the amount of computation by 89% and 98%, respectively. Meanwhile, for the ball query algorithm, when the size of the search window is set to 8×8, it is possible to reduce the amount of external memory access and the amount of computation by 97% and 91%, respectively. In addition, for the K-nearest neighbor algorithm, when the size of the search window is set to 4×4, it is possible to reduce both the amount of external memory access and the amount of computation by 99%.

The sampling unit 130 samples the depth image in units of a sampling window having a predetermined arbitrary size (e.g. N×N, where N is a multiple of 4). To this end, the sampling unit 130 includes a window generation unit 131, a 3D point data conversion unit 132, a distance calculation unit 133, a sample point data determination unit 134, and an output buffer 135.

The window generation unit 131 generates the sample window under control of the controller 200. At this time, the window generation unit 131 may generate the sampling window such that the sampling window is disposed on the depth image at predetermined intervals while covering the entirety of the depth image. To this end, the controller 200 may store predetermined sampling window information in advance or may receive predetermined information for sampling window generation to control the window generation unit 131. Meanwhile, the predetermined information for sampling window generation may include the size and position information of the sampling window and the number of sampling windows. It is preferable for the number of sampling windows to be equal to the number of predetermined 3D point data in order to accelerate a 3D point cloud-based deep learning neural network. That is, the controller 200 may determine the number of sampling windows based on the number of sampling points generally required for the 3D point cloud-based deep learning neural network, and may control the window generation unit 131 based on the result.

The 3D point data conversion unit 132 loads depth data stored in the depth data storage unit 120 in units of the sampling window, and converts the depth data into 3D point data. To this end, the controller 200 may receive sampling window information from the window generation unit 131, may load depth data from the depth data storage unit 120 based on the sampling window information, and may transmit the depth data to the 3D point data conversion unit 132.

The distance calculation unit 133 calculates the distance between each of all 3D point data included in the sampling window and arbitrary sampling reference 3D point data. To this end, the controller 200 may receive 3D point data in units of the sampling window from the 3D point data conversion unit 132, and may transmit the 3D point data to the distance calculation unit 133 together with the reference 3D point data. At this time, the reference 3D point data may be representative 3D point data sampled in the previous step when sampling is sequentially performed with respect to a plurality of sampling windows.

The sample point data determination unit 134 determines 3D point data having a distance from the reference 3D point data greater than a predetermined first distance critical value based on the result of distance calculation by the distance calculation unit 133 as the representative 3D point data.

The output buffer 135 stores the result of sampling. To this end, the controller 200 transmits the result of sampling, i.e. the representative 3D point data, from the sample point data determination unit 134 to the output buffer 135, and the output buffer 135 stores indexes of the representative 3D point data into an index (Idx) storage unit and coordinate values of the representative 3D point data into a coordinates storage unit 20 in a separated state.

The grouping unit 140 generates a grouping window having a predetermined arbitrary size (e.g. n×n, where n is a multiple of 4) based on the result of sampling, and groups inner 3D point data by grouping window. To this end, the grouping unit 140 includes a window generation unit 141, a 3D point data conversion unit 142, a distance calculation unit 143, a group determination unit 144, and an output buffer 145.

The window generation unit 141 generates the grouping window under control of the controller 200. At this time, the window generation unit 141 may generate the grouping window based on the representative 3D point data. To this end, the controller 200 may transmit indexes and coordinate values of the representative 3D point data stored in the output buffer 135 as the result of sampling to the window generation unit 141.

The 3D point data conversion unit 142 loads depth data stored in the depth data storage unit 120 in units of the grouping window, and converts the depth data into 3D point data. To this end, the controller 200 may receive grouping window information from the window generation unit 141, may load depth data from the depth data storage unit 120 based on the grouping window information, and may transmit the depth data to the 3D point data conversion unit 142.

The distance calculation unit 143 calculates the distance between each of all 3D point data included in the grouping window and the representative 3D point data, which are the result of sampling. To this end, the controller 200 may receive 3D point data in units of the grouping window from the 3D point data conversion unit 142, and may transmit the 3D point data to the distance calculation unit 133 together with the representative 3D point data.

The group determination unit 144 determines 3D point data having a distance from the representative 3D point data less than a predetermined second distance critical value based on the result of distance calculation by the distance calculation unit 143 to be one group.

The output buffer 145 stores the result of grouping. To this end, the controller 200 transmits two or more 3D point data determined to be one group from the group determination unit 144 to the output buffer 145, and the output buffer 145 stores indexes of the two or more 3D point data into the index (Idx) storage unit 10 and coordinate values of the two or more 3D point data into the coordinates storage unit 20 in a separated state.

Meanwhile, as illustrated in FIG. 1, the window generation unit 131, the 3D point data conversion unit 132, the distance calculation unit 133, and the output buffer 135 of the sampling unit 130 and the window generation unit 141, the 3D point data conversion unit 142, the distance calculation unit 143, and the output buffer 145 of the grouping unit 140 may be shared.

That is, the window generation unit 131 of the sampling unit 130 and the window generation unit 141 of the grouping unit 140 may be implemented by one window generator configured to generate a window based on input window generation information, and the window generator may be operated to generate the sampling window based on first setting information input from the controller 200 (sampling controller) in order to generate the sampling window or to generate the grouping window based on second setting information input from the controller 200 (grouping controller) in order to generate the grouping window.

In addition, the 3D point data conversion unit 132 of the sampling unit 130 and the 3D point data conversion unit 142 of the grouping unit 140 may be implemented by one data converter configured to convert input depth data into 3D point data, and the data converter may be operated to convert depth data loaded in units of the sampling window into 3D points under control of the controller 200 (sampling controller) or to convert depth data loaded in units of the grouping window into 3D points under control of the controller 200 (grouping controller).

In addition, the distance calculation unit 133 of the sampling unit 130 and the distance calculation unit 143 of the grouping unit 140 may be implemented by one distance calculator configured to calculate the distance between input 3D points, and the distance calculator may be operated to calculate the distance between each of all 3D point data included in the sampling window and arbitrary sampling reference 3D point data under control of the controller 200 (sampling controller) or to calculate the distance between each of all 3D point data included in the grouping window and the representative 3D point data under control of the controller 200 (grouping controller).

In addition, the output buffer 135 of the sampling unit 130 and the output buffer 145 of the grouping unit 140 may be implemented by one buffer memory configured to temporarily store input information, and the buffer memory may be operated to store the result of sampling under control of the controller 200 (sampling controller) or to store the result of grouping under control of the controller 200 (grouping controller).

In the present invention, as described above, the sampling unit 130 and the grouping unit 140 are designed as an integrated dedicated hardware unit configured not to perform individual computation but to share the window search unit and the memory when 3D point data of the depth image are searched based on the search window, whereby it is possible to reduce the area of the hardware unit. An example of a processor unit designed such that the sampling unit 130 and the grouping unit 140 share a specific hardware unit (unified point processing unit) is illustrated in FIG. 3.

FIG. 3 is a view showing an example of a processing unit configured to perform sampling and grouping in accordance with an embodiment of the present invention. Referring to FIG. 3, the unified point processing unit (UPPU) 310 includes a shared window generator 311, a shared L2 distance calculator 312, a three-dimensional sampling (UDS) module 313, a ball query (BQ) module 314, a K-nearest neighbor (KNN) module 315, and a shared output buffer 316. The shared window generator 311 corresponds to the window generation units 131 and 141 and the 3D point data conversion units 132 and 142 illustrated in FIG. 1, the shared L2 distance calculator 312 corresponds to the distance calculation units 133 and 143 illustrated in FIG. 1, and the shared output buffer 316 corresponds to the output buffers 135 and 145 illustrated in FIG. 1. Each of the shared window generator 311, the shared L2 distance calculator 312, and the shared output buffer 316 is shared by the three-dimensional sampling (UDS) module 313, the ball query (BQ) module 314, and the K-nearest neighbor (KNN) module 315.

In the present invention, as described above, a hardware unit for search in units of a window, data conversion, distance calculation, and output data storage commonly performed during sampling and grouping is designed so as to be shared by the sampling unit 130 (e.g. the three-dimensional sampling (UDS) module 313), the grouping unit 140 (e.g. the ball query (BQ) module 314), and the K-nearest neighbor (KNN) module 315, whereby it is possible to reduce the area by 57.2%, compared to when individual design of the hardware unit is performed.

The convolution computation unit 150 performs convolution computation with respect to the result of grouping performed by the grouping unit 140. At this time, the convolution computation unit 150 separates point feature data, which are not affected by a group value, and group feature data, which are affected by the group value, among channel-direction data of 3D point data constituting the depth image, performs convolution computation with respect to the point feature data and the group feature data, sums the result of convolution computation with respect to the point feature data and the result of convolution computation with respect to the group feature data by group grouped by the grouping unit 140, and derives the final result.

During grouping, one 3D point datum may be grouped into one or more groups, and the convolution computation unit 150 is operated as described above in order to solve a problem of duplicate computation due thereto. That is, in general, only some (channel 0 to channel 2) (hereinafter referred to as group feature data) of channel-direction data (channel 0 to channel (N−1)) of 3D point data have different values between groups, and the other channels (channel 3 to channel (N−1)) (hereinafter referred to as point feature data) have the same value between groups, and therefore the convolution computation unit 150 is operated as described above in order to omit duplicate computation with respect to the point feature data.

To this end, the convolution computation unit 150 includes a computation processing unit 151 configured to process convolution computation, a point feature data computation result storage unit 152 configured to store the result of convolution computation with respect to the point feature data, and a group feature data computation result storage unit 153 configured to store the result of convolution computation with respect to the group feature data. Before grouping, the computation processing unit 151 performs convolution computation with respect to point feature data of all 3D point data included in a depth image target and stores the result of convolution computation in the point feature data computation result storage unit 152. After grouping, the computation processing unit 151 performs convolution computation with respect to group feature data generated as the result of grouping and stores the result of convolution computation in the group feature data computation result storage unit 153. The computation processing unit 151 sums the point feature data and the group feature data of the 3D point data constituting the group by group, and derives the final result.

In the present invention, as described above, the convolution computation unit 150 independently performs convolution computation with respect to the group feature data and the point feature data in the state in which the group feature data and the point feature data are separated from each other, and sums the result of convolution computation depending on the result of grouping, whereby it is possible to omit unnecessary duplicate computation with respect to the point feature data.

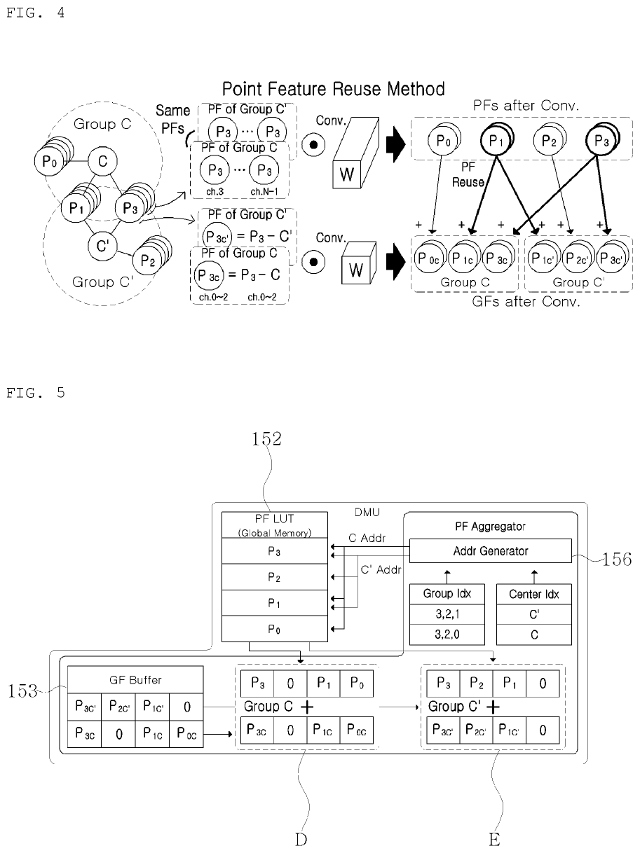

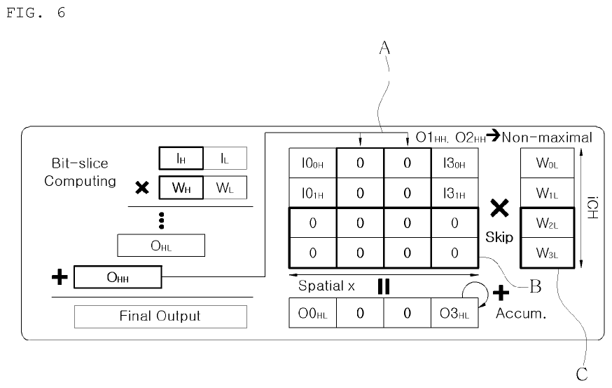

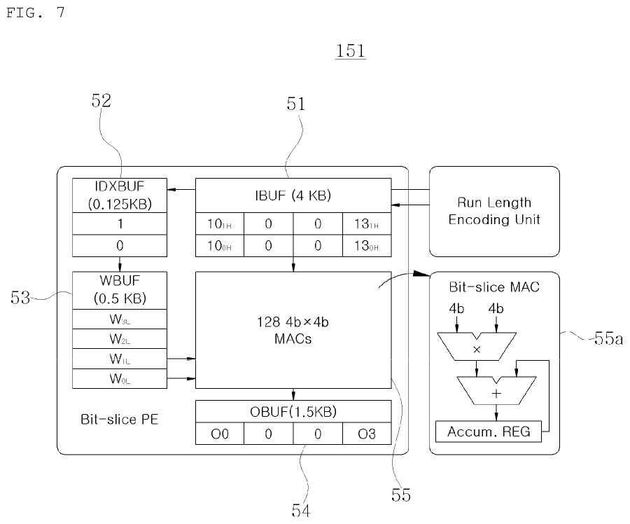

FIGS. 4 and 5 are views schematically illustrating a processing process of the convolution computation unit 150, wherein FIG. 4 is a view schematically illustrating an example of a processing process of dividing point feature data and group feature data from each other, performing convolution computation, and performing summation in accordance with an embodiment of the present invention, and FIG. 5 is a view schematically illustrating an example of the structure of a memory configured to store data generated during convolution computation illustrated in FIG. 4.

Referring first to FIGS. 1, 4, and 5, the convolution computation unit 150 receives the result of grouping stored in the output buffer 145 through the controller 200. FIG. 4 shows an example thereof. Referring to FIG. 4, each of group C and group C′ includes three 3D point data. Group C includes P₀, P₁, and P₃ as members, and group C′ includes P₁, P₂, and P₃ as members. That is, group C and group C′ commonly include P₁ and P₃.

Consequently, the convolution computation unit 150 performs convolution computation with respect to point feature data of all 3D point data derived from the depth image before grouping in order to prevent duplicate computation with respect to 3D point data commonly included in one or more groups. FIG. 4 schematically illustrates an example of a process of performing convolution computation with respect to point feature data of P₃ irrelevant to the result of grouping, group feature data of P₃ grouped in group C, and group feature data of P₃ grouped in group C′ in a separated state, and also schematically illustrates an example of a process of storing the result of convolution computation with respect to the point feature data of each of P₀, P₁, P₂, and P₃ (PFs after conv.) and the result of convolution computation with respect to the group feature data of each of P₀, P₁, P₂, and P₃ (GFs after conv.) in a separated state and summing the results of convolution computation based on the result of grouping.

Referring to FIGS. 4 and 5, the result of convolution computation with respect to the point feature data of each of P₀, P₁, P₂, and P₃ (PFs after conv.) is stored in a point feature data computation result storage unit (PE Lut) 152, which is a global memory, and the result of convolution computation with respect to the group feature data of each of P₀, P₁, P₂, and P₃ (GFs after conv.) is stored in a group feature data computation result storage unit (GF buffer) 153 by group (see 152 and 153 of FIG. 5). Meanwhile, the result of grouping transmitted from the grouping unit 140 is stored in a PF aggregator, and an address generator (addr generator) 156 generates point feature data access information (C addr and C′ addr) by group using information stored in a state of being divided into group index (group Idx) and center index (center Idx) and accesses a corresponding position of the point feature data computation result storage unit (PE Lut) 152, which is a global memory.

The computation processing unit 151 reads the result of computation with respect to point feature data of 3D point data constituting a corresponding group by group and the result of computation with respect to group feature data of 3D point data constituting a corresponding group by group from the point feature data computation result storage unit 152 and the group feature data computation result storage unit 153, respectively, based on the result of grouping transmitted from the grouping unit 140, sums the results of computation, and derives the final result of convolution computation. FIGS. 4 and 5 shows an example of a process of deriving the result of convolution computation with respect to each of P₀, P₁, and P₃ grouped into group C (P_{0c}+P₀, and P_{3c}+P₃) (D) and the result of convolution computation with respect to each of P₁, P₂, and P₃ grouped into group C (P_{1c}+P₁, P_{2c}+P₂, and P_{3c}+P₃) (E).

As described above, the present 3D point cloud-based deep learning neural network acceleration apparatus according to the embodiment of the present invention has an advantage in that a point feature reuse method of reusing the result of computation with respect to point feature data is used, whereby it is sufficient to perform convolution computation with respect to point feature data of each of P₁ and P₃ only once, and therefore it is possible to accelerate convolution computation. As the number of groups including one arbitrary 3D point datum is increased, such an acceleration effect may be improved.

Furthermore, when the convolution computation unit 150 is implemented in a pipeline structure such that convolution computation with respect to point feature data and convolution computation with respect to group feature data are performed by parallel processing, the acceleration effect may be further improved without computation delay.

In addition, the convolution computation unit 150 slices input data and weight, which are convolution computation targets, to upper bits and lower bits, respectively, performs convolution computation with respect to the sliced input data in chronological order, accumulates the results of convolution computation, and produces the final result, whereby it is possible to accelerate convolution computation.

To this end, the computation processing unit 151 of the convolution computation unit 150 includes a bit-slice unit calculator, and the bit-slice unit calculator performs convolution computation with respect to input data sliced into a specific bit unit (e.g. 4, 8, 12, or 16 bits).

At this time, the bit-slice unit calculator performs convolution computation in the state in which L sliced input data are set to one computation unit. When the computation unit data (i.e. L sliced input data) are all 0, weight computation with respect to the computation unit data may be skipped. That is, sparse input computation may be skipped.

In addition, the convolution computation unit 150 may perform computation with respect to the upper bit data, among the sliced input data, first, may predict the position of the max-pooling maximum value based on a result value thereof, and may skip computation with respect to the lower bit data at different positions from the position of the max-pooling maximum value. That is, output computation may be skipped.

FIGS. 6 and 7 are views illustrating the operation and structure of the bit-slice unit calculator, wherein FIG. 6 is a view schematically illustrating a convolution computation process having sparse input and output computation skipping applied thereto by slice-computing a computation target in accordance with an embodiment of the present invention, and FIG. 7 is a view schematically illustrating an example of the structure of a bit-slice computer configured to perform convolution computation illustrated in FIG. 6.

For example, the operation of the bit-slice unit calculator when 8-bit data input and weight are computed will be described with reference to FIGS. 6 and 7.

Referring first to FIG. 6, the bit-slice unit calculator slices the 8-bit data input and weight into 4-bit units (i.e. upper 4-bits and lower 4-bits) (I_{H}, I_{L}, W_{H}, and W_{H}), performs each unit computation in chronological order, accumulates results ( . . . , O_{HL}, and O_{HH}), and produces the final output. At this time, when four continuous 4-bit data have a value of 0 in a spatial direction of the input data, weight computation multiplied by the four may be skipped. That is, in the example of FIG. 6, when four continuous 4-bit data have a value of 0, as in a first area B indicated by a blue box, computation with a corresponding weight may be omitted.

In addition, the bit-slice unit calculator calculates upper 4-bit input data and 4-bit weight data first to measure the size of the result of computation, and predicts the position of the max-pooling maximum value based on the result thereof. That is, the max-pooling maximum value is predicted through the result of multiplication, and for output not predicted as the maximum value, the value A of corresponding input data when lower 4-bit computation is performed is set to 0, as in a third area A indicated by a red box in the example of FIG. 6. In the present invention, as described above, a large number of 0 values may be skipped utilizing an input data value of 0 additionally generated.

Referring to FIG. 7, first, the computation processing unit 151 having the bit-slice computer includes an input memory (IBUF) 51, an index memory (IDXBUF) 52, a weight memory (WBUF) 53, an output memory (OBUF) 54, and a 128 4-bit unit multiplication and addition computer (MAC) 55. Reference symbol 55a indicates the detailed construction of the multiplication and addition computer (MAC).

The input memory (IBUF) 51 stores input data not having a value of 0 generated through a run length encoding unit, the index memory (IDXBUF) 52 stores an index value indicating the position of the input data, the weight memory (WBUF) 53 stores weight data, the output memory (OBUF) 54 stores the result of bit-slice computation, and the 128 4-bit unit multiplication and addition computer (MAC) 55 reads input data from the input memory (IBUF) 51, position information of the input data from the index memory (IDXBUF) 52, and corresponding weight data from the weight memory (WBUF) 53, multiplies the input data by the weight data, and stores the result of multiplication in the output memory (OBUF) 54. At this time, as illustrated in FIG. 6, a value of 0 generated with respect to input/output data satisfying a specific condition is stored in the input memory (IBUF) 51 and the index memory (IDXBUF) 52, whereby sparse input and output data may be efficiently skipped.

As described above, the convolution computation unit 150 may achieve a speed 22.5% faster than before and an energy delay product value 50.1% lower than before through bit-slice computation. When a speed 31.9% faster than before and an energy delay product value 62.7% lower than before are achieved by further applying the point feature reuse method according to the present invention, a low energy delay product value may be achieved in addition to the bit-slice unit skipping effect.

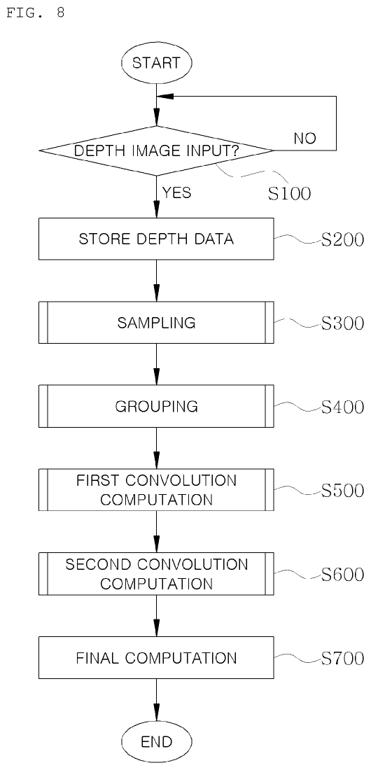

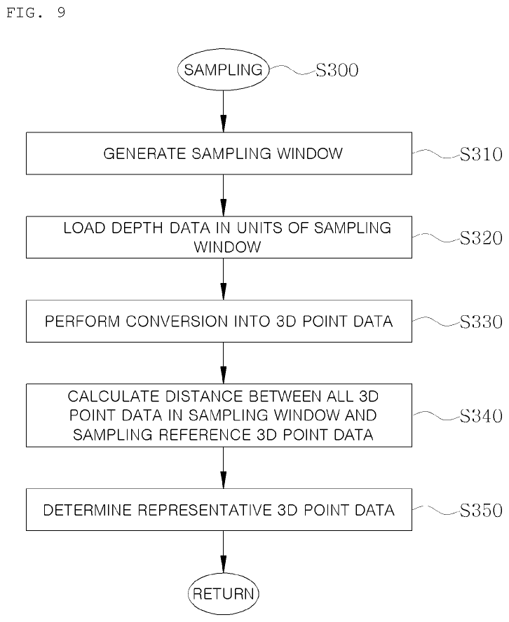

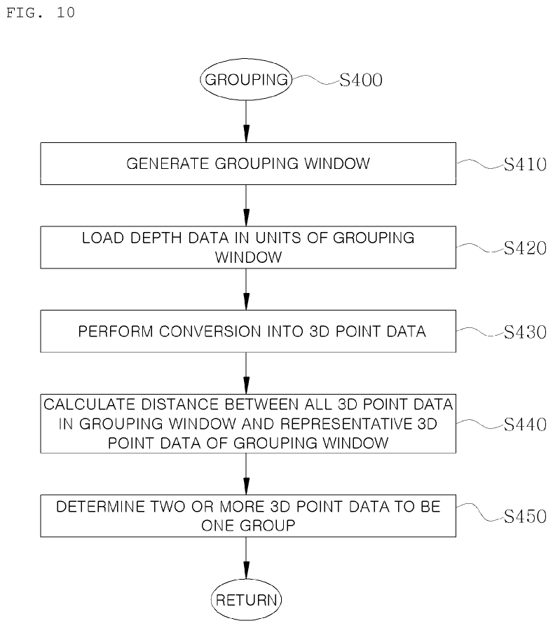

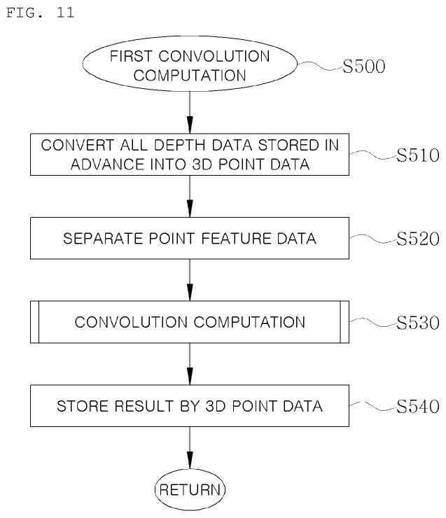

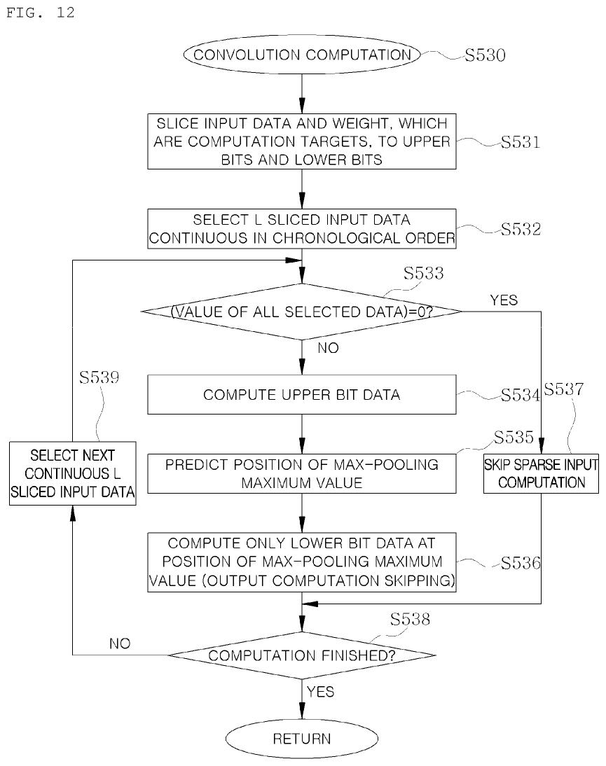

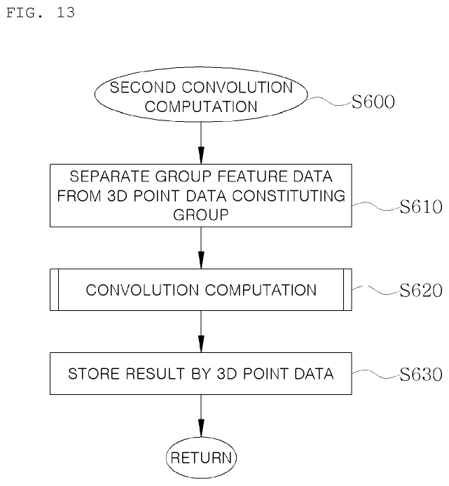

FIGS. 8 to 13 are flowcharts showing a 3D point cloud-based deep learning neural network acceleration method according to an embodiment of the present invention, wherein FIG. 8 is a flowchart schematically showing the 3D point cloud-based deep learning neural network acceleration method, FIG. 9 is a flowchart of a sampling process illustrated in FIG. 8, FIG. 10 is a flowchart of a grouping process illustrated in FIG. 8, FIG. 11 is a flowchart of a first convolution computation process illustrated in FIG. 8, and FIG. 12 is a flowchart of the convolution computation process illustrated in FIG. 11.

Hereinafter, the 3D point cloud-based deep learning neural network acceleration method using the 3D point cloud-based deep learning neural network acceleration apparatus according to the embodiment of the present invention will be described with reference to FIGS. 1 and 8 to 13.

In step S100, the controller 200 determines whether a depth image, which is a training target, has been input through the depth image input unit 110. In step S200, the controller 200 stores the depth image in the depth data storage unit 120.

In step S300, the sampling unit 130 samples the depth image. Specifically, the sampling unit 130 samples the depth image in units of a sampling window having a predetermined first size (e.g. N×N, where N is a multiple of 4).

To this end, in step S310, the window generation unit 131 generates a sampling window. At this time, the window generation unit 131 generates the sampling window such that the sampling window is disposed on the depth image at predetermined intervals while covering the entirety of the depth image. In particular, the window generation unit 131 generates sampling windows equal in number to predetermined 3D point data in order to accelerate the 3D point cloud-based deep learning neural network.

Also, in step S320 and step S330, the 3D point data conversion unit 132 loads depth data stored in the depth data storage unit 120 in units of the sampling window, and converts the depth data into 3D point data. In step S340, the distance calculation unit 133 calculates the distance between each of all 3D point data included in the sampling window and arbitrary sampling reference 3D point data. In step S350, the sample point data determination unit 134 determines 3D point data having a distance from the reference 3D point data greater than a predetermined first distance critical value based on the result of distance calculation to be representative 3D point data.

The construction and detailed operation of the sampling unit 130 configured to perform the above steps have already been described with reference to FIGS. 1 to 7, and therefore a duplicate description thereof will be omitted.

In step S400, the grouping unit 140 generates a grouping window based on the result of sampling.

Specifically, the grouping unit 140 generates a grouping window having a predetermined second size (e.g. n×n, where n is a multiple of 4) based on the result of sampling, and groups inner 3D point data by grouping window.

To this end, in step S410, the window generation unit 141 generates the grouping window based on the representative 3D point data determined by sampling window.

Also, in step S420 and step S430, the 3D point data conversion unit 142 loads depth data constituting the depth image in units of the grouping window, and converts the depth data into 3D point data. In step S440, the distance calculation unit 143 calculates the distance between each of all 3D point data included in the grouping window and the representative 3D point data, which are the center of the grouping window. In step S450, the group determination unit 144 determines two or more 3D point data having a distance from the representative 3D point data less than a predetermined second distance critical value based on the result of distance calculation to be one group.

The construction and detailed operation of the grouping unit 140 configured to perform the above steps have already been described with reference to FIGS. 1 to 7, and therefore a duplicate description thereof will be omitted.

In step S500, the convolution computation unit 150 separates only point feature data, which are not affected by a group value, from channel-direction data of all 3D point data included in the depth image, performs convolution computation with respect to the point feature data, and stores the result of convolution computation in the point feature data computation result storage unit 152.

To this end, in step S510 and step S520, the computation processing unit 151 converts all depth data stored in the depth data storage unit 120 in advance into 3D point data, and separates point feature data from the 3D point data. In step S530, the computation processing unit 151 performs convolution computation with respect to the point feature data.

For convolution computation, the computation processing unit 151 slices input data and weight, which are convolution computation targets, to upper bits and lower bits, respectively, performs convolution computation with respect to the sliced input data in chronological order, accumulates the results of convolution computation, and produces the final result. That is, in step S531, the computation processing unit 151 slices input data (i.e. point feature data) and weight, which are computation targets, to upper bits and lower bits, respectively, and sets L sliced input data to one computation unit. In step S532, the computation processing unit 151 selects L sliced input data continuous in chronological order in order to perform computation.

In step S533, the computation processing unit 151 determines whether the value of all of the selected data is 0. When the value of all of the selected data is 0, i.e. when all of the computation unit data are 0, weight computation with respect to the computation unit data is skipped. That is, when the above condition is satisfied, the computation processing unit 151 skips minimum input computation in step S537.

On the other hand, upon determining in step S533 that the value of all of the selected data is not 0, the computation processing unit 151 performs computation with respect to the upper bit data, among the sliced input data, first in step S534, and predicts the position of the max-pooling maximum value based on a result value of the computation in step S535. In step S536, the computation processing unit 151 skips computation with respect to the lower bit data at different positions from the position of the max-pooling maximum value based on the result of prediction (output computation skipping).

Until finishing of computation is confirmed in step S538, the computation processing unit 151 selects the next L continuous sliced data in step S539, and repeatedly performs step S533 to step S537. When finishing of computation is confirmed in step S538, the computation processing unit 151 finishes a computation algorithm.

In step S540, the computation processing unit 151 stores the result of first convolution computation. Specifically, the computation processing unit 151 stores the result of first convolution computation in the point feature data computation result storage unit 152 by 3D point data.

In step S600, the convolution computation unit 150 separates only group feature data, which are affected by the group value, from channel-direction data of 3D point data constituting each group by group grouped in step S400, performs convolution computation with respect to the group feature data, and stores the result of convolution computation in the group feature data computation result storage unit 153.

To this end, the computation processing unit 151 separates group feature data from 3D point data constituting the group in step S610, and performs convolution computation with respect to the group feature data in step S620. The detailed processing process of step S620 is identical to the convolution computation process (S530) illustrated in FIG. 12, and therefore a duplicate description thereof will be omitted.

In step S630, the computation processing unit 151 stores the result of second convolution computation. Specifically, the computation processing unit 151 stores the result of second convolution computation in the group feature data computation result storage unit 153 by 3D point data.

In step S700, the computation processing unit 151 sums the result of computation in the first convolution computation step and the result of computation in the second convolution computation step with respect to each of the 3D point data constituting each group, and derives the final result of computation.

The construction and detailed operation of the convolution computation unit 150 configured to perform step S500 to step S700 have already been described with reference to FIGS. 1 to 7, and therefore a duplicate description thereof will be omitted.

Meanwhile, the convolution computation unit 150 is implemented in a pipeline structure such that the first convolution computation in step S500 and the second convolution computation in step S600 temporarily overlap so as to be performed by parallel processing, whereby convolution computation acceleration may be further improved.

As described above, the present invention has an advantage in that the search area of the window-based 3D point search algorithm is limited to units of a window having a size of N×N (N=4, 8, 12, 16, . . . ), whereby it is possible to greatly reduce the amount of external memory access and the amount of computation, and therefore it is possible to increase speed.

In addition, the present invention has an advantage in that the memory configured to store the result of sampling and the result of grouping is shared, whereby it is possible to reduce consumption of hardware resources.

In addition, the present invention has an advantage in that sparse input and output skipping is applied to 3D point cloud-based deep learning neural network acceleration, whereby it is possible to accelerate convolution computation.

In addition, the present invention has advantages in that the result of computation of point feature data is reused, whereby it is possible to omit a duplicate convolution computation process, and therefore it is possible to accelerate convolution computation, and in that convolution computation with respect to the point feature data and convolution computation with respect to the group feature data are performed by parallel processing, whereby it is possible to further improve convolution computation acceleration.

As is apparent from the above description, a 3D point cloud-based deep learning neural network acceleration apparatus and method according to the present invention has an effect in that it is possible to limit a search area of a window-based 3D point search algorithm to units of a window having a size of N×N (N=4, 8, 12, 16, . . . ), whereby it is possible to greatly reduce the amount of external memory access and the amount of computation, and therefore it is possible to increase speed.

In addition, the 3D point cloud-based deep learning neural network acceleration apparatus and method according to the present invention have an effect in that it is possible to perform control such that, during window search-based 3D point data sampling and grouping, sampling and grouping modules share a hardware unit configured to support window search computation and a memory configured to store the results of sampling and grouping, whereby it is possible to reduce consumption of hardware resources.

In addition, the 3D point cloud-based deep learning neural network acceleration apparatus and method according to the present invention have an effect in that it is possible to, when convolution computation is performed with respect to the result of grouping, slice computation target data to upper bits and lower bits and performing unit computation using the sliced data, whereby it is possible to skip sparse input computation, and therefore it is possible to accelerate convolution computation.

In addition, the 3D point cloud-based deep learning neural network acceleration apparatus and method according to the present invention have an effect in that it is possible to perform computation with respect to upper bit data first to predict the position of the max-pooling maximum value and to skip computation with respect to lower bit data at different positions from the position of the max-pooling maximum value, whereby it is possible to skip output computation, and therefore it is possible to accelerate convolution computation.

In addition, the 3D point cloud-based deep learning neural network acceleration apparatus and method according to the present invention have an effect in that it is possible to separate point feature data, which are not affected by a group value, thereby having the same value, and group feature data, which are affected by the group value, thereby having different values depending on group, among channel-direction data of 3D point data belonging to a plurality of groups, during grouping, and to perform convolution computation with respect to the point feature data and the group feature data, whereby it is possible to omit duplicate computation with respect to the point feature data, and therefore it is possible to accelerate convolution computation.

In addition, the 3D point cloud-based deep learning neural network acceleration apparatus and method according to the present invention have an effect in that it is possible to perform convolution computation with respect to the point feature data and convolution computation with respect to the group feature data by parallel processing through hardware having a pipeline structure, whereby it is possible to further accelerate convolution computation.

Although the embodiment of the present invention has been described above, the scope of right of the present invention is not limited thereto and includes all alterations and modifications within a range easily changed and recognized as being equivalent by a person having ordinary skill in the art to which the present invention pertains from the embodiment of the present invention.

What is claimed is:

1. A 3D point cloud-based deep learning neural network acceleration apparatus comprising:
a depth image input unit configured to receive a depth image, which is a training target;
a depth data storage unit configured to store depth data derived from the depth image;
a sampling unit configured to sample the depth image in units of a sampling window having a predetermined first size;
a grouping unit configured to generate a grouping window having a predetermined second size based on a result of sampling and to group inner 3D point data by grouping window; and
a convolution computation unit configured to separate point feature data, which are not affected by a group value, and group feature data, which are affected by the group value, among channel-direction data of 3D point data constituting the depth image, to perform convolution computation with respect to the point feature data and the group feature data, to sum a result of convolution computation with respect to the point feature data and a result of convolution computation with respect to the group feature data by group grouped by the grouping unit, and to derive a final result.

2. The 3D point cloud-based deep learning neural network acceleration apparatus according to claim 1, wherein the sampling unit comprises:
a sampling window generation unit configured to generate the sample window;
a first 3D point data conversion unit configured to load depth data stored in the depth data storage unit in units of the sampling window and to convert the depth data into 3D point data;
a first distance calculation unit configured to calculate a distance between each of all 3D point data included in the sampling window and arbitrary sampling reference 3D point data;
a sample point data determination unit configured to determine 3D point data having a distance from the reference 3D point data greater than a predetermined first distance critical value based on a result of distance calculation by the distance calculation unit to be representative 3D point data; and
a sampling controller configured to control operation of the sampling window generation unit, the first 3D point data conversion unit, the first distance calculation unit, and the sample point data determination unit according to a predetermined sampling algorithm.

3. The 3D point cloud-based deep learning neural network acceleration apparatus according to claim 2, wherein the sampling window generation unit generates the sampling window such that the sampling window is disposed on the depth image at predetermined intervals while covering an entirety of the depth image and generates sampling windows equal in number to predetermined 3D point data in order to accelerate a 3D point cloud-based deep learning neural network.

4. The 3D point cloud-based deep learning neural network acceleration apparatus according to claim 2, wherein the grouping unit comprises:
a grouping window generation unit configured to generate the grouping window based on the representative 3D point data;
a second 3D point data conversion unit configured to load depth data constituting the depth image in units of the grouping window and to convert the depth data into 3D point data;
a second distance calculation unit configured to calculate a distance between each of all 3D point data included in the grouping window and the representative 3D point data;
a group determination unit configured to determine two or more 3D point data having a distance from the representative 3D point data less than a predetermined second distance critical value based on a result of distance calculation by the second distance calculation unit to be one group; and
a grouping controller configured to control operation of the grouping window generation unit, the second 3D point data conversion unit, the second distance calculation unit, and the group determination unit according to a predetermined grouping algorithm.

5. The 3D point cloud-based deep learning neural network acceleration apparatus according to claim 4, wherein
the sampling window generation unit and the grouping window generation unit are implemented by one window generator configured to generate a window based on input window generation information, and
the window generator generates the sampling window based on first setting information input from the sampling controller in order to generate the sampling window or generates the grouping window based on second setting information input from the grouping controller in order to generate the grouping window.

6. The 3D point cloud-based deep learning neural network acceleration apparatus according to claim 4, wherein
the first 3D point data conversion unit and the second 3D point data conversion unit are implemented by one data converter configured to convert input depth data into 3D point data, and
the data converter converts depth data loaded in units of the sampling window into 3D points under control of the sampling controller or converts depth data loaded in units of the grouping window into 3D points under control of the grouping controller.

7. The 3D point cloud-based deep learning neural network acceleration apparatus according to claim 4, wherein
the first distance calculation unit and the second distance calculation unit are implemented by one distance calculator configured to calculate a distance between input 3D points, and
the distance calculator calculates a distance between each of all 3D point data included in the sampling window and arbitrary sampling reference 3D point data under control of the sampling controller or calculates a distance between each of all 3D point data included in the grouping window and the representative 3D point data under control of the grouping controller.

8. The 3D point cloud-based deep learning neural network acceleration apparatus according to claim 4, further comprising:
an output buffer configured to temporarily store the result of sampling and the result of grouping, wherein
the output buffer stores indexes and coordinate values of the representative 3D point data in a separated state under control of the sampling controller or stores indexes and coordinate values of 3D point data included in the grouped group in a separated state under control of the grouping controller.

9. The 3D point cloud-based deep learning neural network acceleration apparatus according to claim 1, wherein the convolution computation unit slices input data and weight, which are convolution computation targets, to upper bits and lower bits, respectively, performs convolution computation with respect to the sliced input data in chronological order, accumulates results of convolution computation, and produces a final result.

10. The 3D point cloud-based deep learning neural network acceleration apparatus according to claim 9, wherein
the convolution computation unit performs computation in a state in which L sliced input data are set to one computation unit, and
when the computation unit data are all 0, weight computation with respect to the computation unit data is skipped.

11. The 3D point cloud-based deep learning neural network acceleration apparatus according to claim 10, wherein the convolution computation unit performs computation with respect to the upper bit data, among the sliced input data, first, predicts a position of a max-pooling maximum value based on a result value thereof, and skips computation with respect to the lower bit data at different positions from the position of the max-pooling maximum value.

12. The 3D point cloud-based deep learning neural network acceleration apparatus according to claim 1, wherein the convolution computation unit is implemented in a pipeline structure such that convolution computation with respect to the point feature data and convolution computation with respect to the group feature data are performed by parallel processing.

13. A 3D point cloud-based deep learning neural network acceleration method comprising:
a sampling step of sampling a depth image, which is a training target, in units of a sampling window having a predetermined first size;
a grouping step of generating a grouping window having a predetermined second size based on a result of sampling and grouping inner 3D point data by grouping window;
a first convolution computation step of separating only point feature data, which are not affected by a group value, from channel-direction data of all 3D point data included in the depth image, performing convolution computation with respect to the point feature data, and storing a result of convolution computation;
a second convolution computation step of separating only group feature data, which are affected by the group value, from channel-direction data of 3D point data constituting each group by grouped group, performing convolution computation with respect to the group feature data, and storing a result of convolution computation; and
a final computation step of summing a result of computation in the first convolution computation step and a result of computation in the second convolution computation step with respect to each of the 3D point data constituting each group by group.

14. The 3D point cloud-based deep learning neural network acceleration method according to claim 13, wherein the sampling step comprises:
a first loading step of loading depth data constituting the depth image in units of the sampling window;
a first conversion step of converting the loaded depth data into 3D point data;
a first distance calculation step of calculating a distance between each of all 3D point data included in the sampling window and arbitrary sampling reference 3D point data; and
a first determination step of determining 3D point data having a distance from the reference 3D point data greater than a predetermined first distance critical value based on a result of distance calculation in the first distance calculation step to be representative 3D point data.

15. The 3D point cloud-based deep learning neural network acceleration method according to claim 14, wherein the sampling step further comprises a sampling window generation step of generating the sampling window such that the sampling window is disposed on the depth image at predetermined intervals while covering an entirety of the depth image and generating sampling windows equal in number to predetermined 3D point data in order to accelerate a 3D point cloud-based deep learning neural network.

16. The 3D point cloud-based deep learning neural network acceleration method according to claim 14, wherein the grouping step comprises:
a grouping window generation step of generating a grouping window based on the representative 3D point data determined by sampling window;
a second loading step of loading depth data constituting the depth image in units of the grouping window;
a second conversion step of converting the loaded depth data into 3D point data;
a second distance calculation step of calculating a distance between each of all 3D point data included in the grouping window and the representative 3D point data, which are a center of the grouping window; and
a second determination step of determining two or more 3D point data having a distance from the representative 3D point data less than a predetermined second distance critical value based on a result of distance calculation in the second distance calculation step to be one group.

17. The 3D point cloud-based deep learning neural network acceleration method according to claim 13, wherein each of the first and second convolution computation steps slices input data and weight, which are convolution computation targets, to upper bits and lower bits, respectively, performs convolution computation with respect to the sliced input data in chronological order, accumulates results of convolution computation, and produces a final result.

18. The 3D point cloud-based deep learning neural network acceleration method according to claim 17, wherein
each of the first and second convolution computation steps performs computation in a state in which L sliced input data are set to one computation unit, and
each of the first and second convolution computation steps comprises a sparse input skipping step of, when the computation unit data are all 0, skipping weight computation with respect to the computation unit data.

19. The 3D point cloud-based deep learning neural network acceleration method according to claim 18, wherein each of the first and second convolution computation steps further comprises:
a maximum value position prediction step of performing computation with respect to the upper bit data, among the sliced input data, first, and predicting a position of a max-pooling maximum value based on a result value thereof; and
an output computation skipping step of skipping computation with respect to the lower bit data at different positions from the position of the max-pooling maximum value.

20. The 3D point cloud-based deep learning neural network acceleration method according to claim 13, wherein the first convolution computation step and the second convolution computation step temporarily overlap so as to be performed by parallel processing.
